(19) United States
(12) Patent Application Publication
(10) Pub. No.: US 2015/0364129 A1
(43) Pub. Date: Dec. 17, 2015

(54) Language Identification

(71) Applicant: Google Inc., Mountain View, CA (US)

(72) Inventors: Javier Gonzalez-Dominguez, Madrid (ES); Ignacio L. Moreno, New York, NY (US); David P. Eustis, New York, NY (US)

(21) Appl. No.: 14/313,490

(22) Filed: Jun. 24, 2014

Related U.S. Application Data
(60) Provisional application No. 62/013,383, filed on Jun. 17, 2014.

(51) Int. Cl. G10L 15/00; G10L 15/02

(52) U.S. Cl. CPC G10L 15/005; G10L 15/02

(57) ABSTRACT

Methods, systems, and apparatus, including computer programs encoded on a computer storage medium, for language identification. In some implementations, speech data for an utterance is received and provided to (i) a language identification module and (ii) multiple speech recognizers that are each configured to recognize speech in a different language. From the language identification module, language identification scores corresponding to different languages are received, the language identification scores each indicating a likelihood that the utterance is speech in the corresponding language. A language model confidence score that indicates a level of confidence that a language model has in a transcription of the utterance in a language corresponding to the language model is received. A language is selected based on the language identification scores and the language model confidence scores.

### CROSS-REFERENCE TO RELATED APPLICATIONS

This application claims priority from U.S. Provisional Application Ser. No. 62/013,383, filed Jun. 17, 2014, the entire contents of which is incorporated herein by reference.

### TECHNICAL FIELD

The present document relates to automatic language identification.

### BACKGROUND

Speech-to-text systems can be used to generate a textual representation of a verbal utterance. Speech-to-text systems typically attempt to use various characteristics of human speech, such as the sounds produced, rhythm of speech, and intonation, to identify the words represented by such characteristics. Many speech-to-text systems are configured to recognize speech in a single language, or require a user to manually designate which language the user is speaking.

### SUMMARY

In some implementations, a computing system can automatically determine which language a user is speaking and transcribe speech in the appropriate language. For example, when a bilingual user alternates between speaking two different languages, the system may detect the change in language and transcribe speech in each language correctly. For example, if speech provided in a dictation session includes speech in different languages, the system may automatically detect which portions of the speech are in a first language, and which portions are in a second language. This may allow the system to transcribe the speech correctly, without requiring the user to manually indicate which language the user is speaking while dictating.

The system may identify the language that the user is speaking using a language identification module as well as speech recognizers for different languages. For example, each speech recognizer may attempt to recognize input speech in a single language. Each speech recognizer may provide a confidence score, such as a language model confidence score, indicating how likely its transcription is to be correct. The system may then use output of the language identification module and the speech recognizers to determine which language was most likely spoken. With the language identified, the system may provide the user a transcript of the user's speech in the identified language.

In one aspect, a method performed by one or more computers includes receiving speech data for an utterance. The method further includes providing the speech data to (i) a language identification module and (ii) multiple speech recognizers that are each configured to recognize speech in a different language. The method further includes receiving, from the language identification module, language identification scores corresponding to different languages, the language identification scores each indicating a likelihood that the utterance is speech in the corresponding language. The method further includes receiving, from each of the multiple speech recognizers, a language model confidence score that indicates a level of confidence that a language model has in a transcription of the utterance in a language corresponding to the language model. The method further includes selecting a language based on the language identification scores and the language model confidence scores.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

Implementations can include any, all, or none of the following features. For example, receiving the speech data for the utterance includes receiving the speech data from a user over a network; wherein the method further includes receiving, from each of the speech recognizers, a transcription of the utterance in a language corresponding to the speech recognizer; and providing the transcription in the selected language to the user over the network. The method including before receiving, from each of the speech recognizers, a transcription of the utterance in a language corresponding to the speech recognizer: receiving, from a particular one of the multiple speech recognizers, a preliminary transcription of the utterance in a language corresponding to the speech recognizer; providing the preliminary transcription to the user over the network before providing the transcription in the selected language to the user over the network. In some instances, the preliminary transcription is in the selected language. In some other instances, the preliminary transcription is a language different than the selected language. The preliminary transcription is provided over the network for display to the user; and wherein the transcription in the selected language is provided for display in place of the preliminary transcription, after the preliminary transcription has been provided over the network.

Implementations can include any, all, or none of the following features. For example, the method further includes receiving, from the particular one of the multiple speech recognizers, a preliminary language model confidence score that indicates a preliminary level of confidence that a language model has in the preliminary transcription of the utterance in a language corresponding to the language model; and determining that the preliminary language model confidence score is less than a language model confidence score received from the particular one of the multiple speech recognizers. Providing the speech data to a language identification module includes providing the speech data to a neural network that has been trained to provide likelihood scores for multiple languages. Selecting the language based on the language identification scores and the language model confidence scores includes determining a combined score for each of multiple languages, wherein the combined score for each language is based on at least the language identification score for the language and the language model confidence score for the language; and selecting the language based on the combined scores. Determining a combined score for each of multiple languages includes weighting the likelihood scores or the language model confidence scores using one or more weighting values. Receiving the speech data includes receiving speech data that includes an utterance of a user; further including before receiving the speech data, receiving data indicating multiple languages that the user speaks; storing data indicating the multiple languages that the user speaks; wherein providing the speech data to multiple speech recognizers that are each configured to recognize speech in a different language includes based on the stored data indicating the multiple languages that the user speaks, providing the speech data to a set of speech recognizers configured to recognize speech in a different one of the languages that the user speaks.

In one aspect, a non-transitory computer storage medium is tangibly encoded with computer program instructions that, when executed by one or more processors, cause a computer operations to perform operations including receiving speech data for an utterance. The operations further include providing the speech data to (i) a language identification module and (ii) multiple speech recognizers that are each configured to recognize speech in a different language. The operations further include receiving, from the language identification module, language identification scores corresponding to different languages, the language identification scores each indicating a likelihood that the utterance is speech in the corresponding language. The operations further include receiving, from each of the multiple speech recognizers, a language model confidence score that indicates a level of confidence that a language model has in a transcription of the utterance in a language corresponding to the language model. The operations further include selecting a language based on the language identification scores and the language model confidence scores.

In one aspect, a system includes one or more processors and a non-transitory computer storage medium is tangibly encoded with computer program instructions that, when executed by one or more processors, cause a computer operations to perform operations. The operations include receiving speech data for an utterance. The operations further include providing the speech data to (i) a language identification module and (ii) multiple speech recognizers that are each configured to recognize speech in a different language. The operations further include receiving, from the language identification module, language identification scores corresponding to different languages, the language identification scores each indicating a likelihood that the utterance is speech in the corresponding language. The operations further include receiving, from each of the multiple speech recognizers, a language model confidence score that indicates a level of confidence that a language model has in a transcription of the utterance in a language corresponding to the language model. The operations further include selecting a language based on the language identification scores and the language model confidence scores.

The systems and processes described here may be used to provide a number of potential advantages. A user able to speak in multiple languages may use a single system to transcribe utterances, without specifying which language the user wishes to speak. A speech recognition system may store user language preferences or history to aid in determining the language in which the user is speaking. Preliminary transcriptions may be provided quickly to a user while more accurate transcriptions are being generated. Once generated, a more accurate transcription can replace a preliminary transcription. The results of a language identification module and multiple speech recognizers may be combined to produce a result that is more accurate than results of an individual module alone.

Other features, aspects and potential advantages will be apparent from the accompanying description and figures.

### DESCRIPTION OF DRAWINGS

FIG. 1 is a block diagram illustrating an example of a system for language identification and speech recognition.

FIG. 2 is a block diagram illustrating an example of a processing pipeline for a language identification module.

FIG. 3 is a diagram illustrating an example data related to speech recognition confidence scores.

FIGS. 4A and 4B are diagrams illustrating examples of user interfaces.

FIG. 5 is a flowchart illustrating an example of a process for language identification.

FIG. 6 is a schematic diagram that shows examples of a computing device and a mobile computing device.

Like reference symbols in the various drawings indicate like elements

### DETAILED DESCRIPTION

A speech recognition system can be configured to receive an utterance and, as part of creating a transcription of the utterance, determine the language in which the user spoke. This can be very useful for multi-lingual users who may speak in different languages at different times, and may switch between languages in the middle of a dictation session.

In some implementations, a speech recognition system can use both a language identification module and a pool of language-specific speech recognizers to determine the language of an utterance. The language identification module may be configured to product a confidence score for each of a plurality of languages. The confidence scores for the language identification module may indicate likelihoods that the utterance was spoken in the respective languages. In addition, each of the language-specific speech recognizers can create a transcription in their specific language and can generate a confidence score for the transcription. The speech recognition system can use both the confidence scores from the language identification module and the speech recognizers to determine the most likely language uttered. The user may then be provided a text-based transcription in the determined language.

As such, the system may be used to dynamically determine the language that is spoken without receiving input that specifies in advance what language of speech will be provided. That is, the user is not required to tap a button to select a language, or speak the name of the language, or take any other action in advance to designate the language that will be spoken. Instead, the user may simply begin speaking the content that the user desires to enter, and the system determines the language automatically as the user speaks. The system may determine what language is spoken based on the sounds of the user's speech, as well as an analysis of the which words those sounds are likely to represent.

From the user's perspective, the system may be configured so that the user may speak in any of multiple languages, possibly changing languages mid-speech, and an appropriate transcription of the speech may be produced with no additional user inputs needed. The user may use the same interface regardless of which language is spoken, and the language may be detected without the user speaking a language-specific key-word before speaking their input or making any other user selection of a specific language in which dictation should occur.

Using the confidence scores for language models and language identification systems together can provide improved accuracy. Language identification scores may provide an estimate based primarily on acoustic properties, and accordingly indicate which language input audio sounds like. Language model scores are typically biased toward the coherence of a sentence or utterance as a whole. For example, language model scores may indicate how likely it is that a series of words is a valid sentence in a given language. Language model scores may also be based on a longer sequence of input than some language identification scores.

Scores based on acoustic signal characteristics are typically most accurate when a user speaks his or her native language. However, for a multi-lingual user or a user with an accent, speech may include acoustic markers or characteristics of multiple languages. Often, a multi-lingual user will have a non-native accent for at least one of the languages spoken. Language model confidence scores can be used to balance out the bias toward acoustic characteristics that frequently occurs in language identification scores. Using both types of confidence scores can provide robustness and accuracy that is better than can be achieved with either type of confidence score alone.

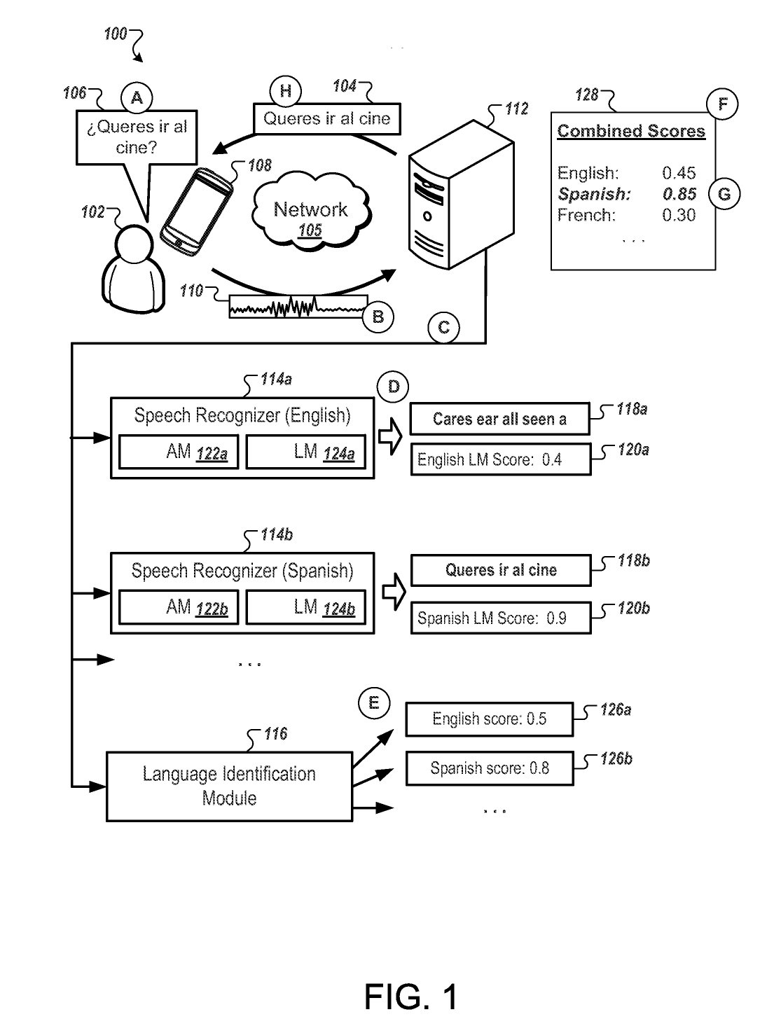

FIG. 1 is a block diagram illustrating an example of a system 100 for language identification and speech recognition. The system 100 includes a client device 108 and a computer system 112 that communicates with the client device 108 over a network 105. The system 100 also includes speech recognizers 114 and a language identification module 116. The figure illustrates a series of states (A) to (H) which illustrates a flow of data, and which may occur in the order shown or in a different order.

The client device 108 can be, for example, a desktop computer, a laptop computer, a cellular phone, a smart phone, a tablet computer, a music player, an e-book reader, a wearable computer, or a navigation system. The functions performed by the computing system 112 can be performed by individual computer systems or can be distributed across multiple computer systems. The network 105 can be wired or wireless or a combination of both, and may include private networks and/or public networks, such as the Internet. The speech recognizers 114 may be implemented on separate computing systems or processing modules, and may be accessed by the computing system 112 via remote procedure calls. In some implementations, functionality of the computing system 112, the speech recognizers 114, and/or the language identification module 116 may be implemented together using one or more computing systems.

In the example of FIG. 1, the user 102 speaks an utterance 106 into the client device 108, and data 110 representing the utterance 106 is transmitted to the computing system 112. The computing system 112 identifies the language of the utterance 106 and provides a transcription 104 for the utterance 106.

The user 102 in this example uses one or more services of the computing system 112. For example, the user 102 may use the speech recognition service for dictation (e.g., speech-to-text transcription). As additional examples, the user 102 may use the speech recognition service that the computing system 112 provides as part of, for example, user authentication and authorization, data hosting, voice search, or cloud applications, such as web-based email, document authoring, web searching, or news reading.

The user 102 may be able to speak in more than one language, and may wish at times to submit spoken input to the client device 108 in different languages. For example, the user may be able to speak English and Spanish, and may dictate emails in either of these languages, depending on the intended recipient of the email. In some implementations, an account associated with the user 102 in the computing system 112 may store data indicating that the user's preferred languages are English and Spanish, or that the user 102 has a history of communicating with the computing system 112 in English and Spanish. This data may have been compiled, for example, based on setting selected by the user 102 and/or records indicative of historical communications with the computing system 112.

In further detail, during stage (A), the user 102 speaks an utterance 106. The client device 108 receives the utterance 106, for example through a microphone built into or connected to the client device 108. The client device 108 can create speech data 110 that represents the utterance 106 using any appropriate encoding technique, either commonly in use or custom-created for this application. The speech data 110 may be, for example, a waveform, a set of speech features, or other data derived from the utterance 106.

During stage (B), the client device 108 sends the speech data 110 to the computing device 112 over the network 105.

During stage (C), to begin the transcription process, the computing system 112 provides the speech data 110, or data derived from the speech data 110, to multiple speech recognizers 114 (e.g., 114a, 114b, and so on) and to a language identification module 116. The computing system 112 requests transcriptions from the speech recognizers 114 and language identification outputs from the language identification module 116. In some implementations, each of the speech recognizers 114 is configured to recognize speech in a single language. In such implementations, each speech recognizer 114 may be a language-specific speech recognizer, with each of the various speech recognizers 114 recognizing a different language.

In some implementations, the computing system 112 makes requests and provides the speech data 110 by making remote procedure calls to the speech recognizers 114 and to the language identification module 116. These requests may be asynchronous and non-blocking. That is, the speech recognizers 114 and the language identification module 116 may each operate independently, and may operate in parallel. The speech recognizers 114 and the language identification module 116 may process requests from the computing system 112 that are at different times, and may complete their processing at different times. The initiation of a request or data transfer to one of the speech recognizers 114 or the language identification module 116 may not be contingent upon, and need not be stopped by, the initiation or completion of processing by any of the other speech recognizers 114 and to a language identification module 116.

When the computing system 112 sends requests to the speech recognizers 114 and to the language identification module 116, the computer system 112 may initiate a timeout clock that increments, for example, every millisecond. The timeout clock can measure a predetermined amount of time in which that the speech recognizers 114 and the language identification module 116 are given to provide responses to the requests from the computing system 112.

In some implementations, information identifying multiple languages that the user 102 speaks may be known. For example, the user 102 may have previously indicated a set of multiple languages that the user 102 speaks. As another example, an email or text messaging account or a web browsing history may indicate languages that the user 102 speaks. The computing system 112 may use this information to limit the number of languages that are evaluated to those that the user 102 is likely to speak. For example, rather than request transcriptions and language identification scores for all languages, the computing system 112 may request transcriptions and scores for only the languages that are associated with or are determined likely to be spoken by the user 102.

During stage (D), each speech recognizer 114 generates a proposed transcription 118 and a confidence score 120 for a particular language. In some implementations, each speech recognizer 114 may use similar processing systems that have access to different acoustic models and/or language models. For example, a speech recognizer 114a generates an English transcription 118a for the speech data 110, using an English acoustic model 122a and an English language model 124a. A speech recognizer 114b generates a Spanish transcription 118b for the speech data 110, using a Spanish acoustic model 122b and a Spanish language model 124b.

In general, acoustic models include data representing the sounds associated with a particular language and phonetic units that the sounds represent. Language models generally include data representing the words, syntax, and common usage patterns of a particular language. The speech recognizers 114a, 114b each produce confidence scores, for example, values that indicate how confident a recognizer or model is in the transcription that was produced. In particular, the language models 124a, 124b generate confidence scores 120a, 120b that indicate how likely it is that the sequence of words in the associated transcription 118a, 118b would occur in typical usage. The language model confidence score 120a indicates a likelihood that the transcription 118a is a valid English language sequence. Similarly, the language model confidence score 120b indicates a likelihood that the transcription 118b is a valid Spanish language sequence. In the example, the Spanish language model confidence score 120b is larger than the English language model confidence score 120a, suggesting that the Spanish transcription 118b is more likely to be correct than the English transcription 118a. This, in turn, indicates that it is more likely that the utterance 106 is a Spanish utterance than an English utterance, as discussed further below. The speech recognizers 114a, 114b send the transcriptions 118a, 118b as well as the language model confidence scores 120a, 120b to the computing system 112.

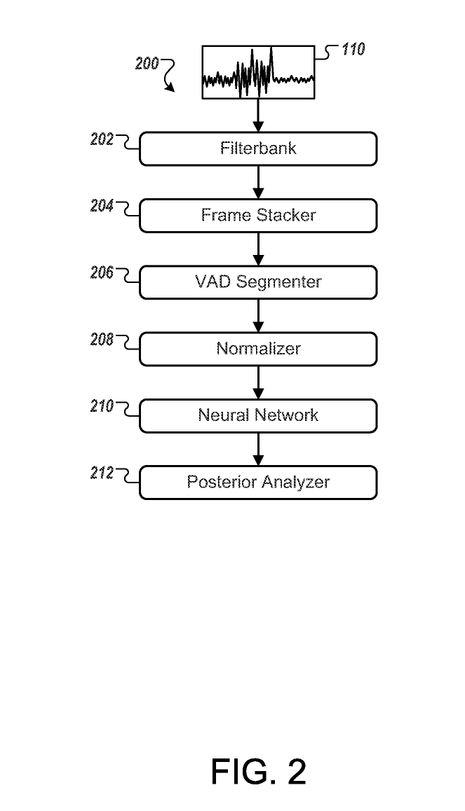

During stage (E), in response to the request and speech data 110 from the computing system 112, the language identification module 116 generates a confidence score for each of a plurality of languages. The language identification module 116 may include one or more models configured to estimate, based on acoustic properties of an audio sample, the likelihood that audio represents speech of a particular language. As discussed further with respect to FIG. 2, the language identification module 116 may include an artificial neural network or other model configured to receive speech features extracted from audio. The artificial neural network or other model may output, for each of several different languages, a confidence score indicating how well the speech features match the properties of a particular language.

In the example, the language identification module 116 provides a confidence score 126a indicating the likelihood that the speech data 110 represents an English utterance. The language identification module 116 also provides a confidence score 126b indicating the likelihood that the speech data 110 represents a Spanish utterance. The confidence score 126b is higher than the confidence score 126a, indicating that the language identification module 116 estimates that there is a higher likelihood that the speech data 110 represents a Spanish utterance than an English utterance. Stage (E) may be designed to be initiated and/or completed at the same time as stage (D) and/or run concurrently with stage (D).

During stage (F), the computing system 112 combines the language model confidence scores 120 and the confidence scores 126 to generate combined scores 128. Any appropriate combination techniques may be used to calculate the combined scores 128. In this example, each combined score 128 represents an arithmetic average of a particular language's language model confidence score 120 and language identification module score 126.

In some configurations, a weighting may be applied to each component confidence score 126 and 120. This may be desirable, for example, if empirical testing (e.g., for a single user 102, for a class of users, for all users) shows that a particular weighting gives more favorable results. For example, language model scores 120 may be slightly more or slightly less predictive of the language spoken than output of the language identification model, and may accordingly be given a slightly higher or lower weight.

In some implementations, additional data may be considered when calculating the combined score 128. For example, if the user 102 is dictating an email addressed to a recipient with a .mx or .es top level domain, which are associated with Mexico and Spain, the combined score 128 for Spanish may be increased based on a likelihood that the recipient speaks that language.

During stage (G), the computing system 112 selects a language based on the combined scores 128. For example, the computing system 112 may identify the combined score 128 that indicates the highest likelihood, and select the language corresponding to this score. In the example, the combined score for the Spanish language indicates a higher likelihood than the combined scores for other languages, so the computing system 112 determines that the utterance 106 is most likely a Spanish utterance.

During stage (H), the computing system 112 transmits transcription 118b for the selected language to the client device 108 as the transcription 104 for the utterance 106. Since the computing system 112 determined that the user 102 was most likely speaking Spanish rather than another language, the Spanish transcription 118b is provided.

Once received, the client device 108 may use or process the transcription 104 as needed. For example, the client device 108 may use the transcription 104 as text input to the application and input field that currently has focus in the client device 108. The computing system 112 may be configured to discard the other proposed transcriptions 118, store them or later use, transmit one or more to the client device 108 in addition to the transcription 104, or take any other appropriate action.

In some configurations, the user 102 may provide, in advance, an indication of multiple language that the user 102 speaks. Using this information, scores and transcriptions may be generated for only the languages that the user 102 has indicated that he is likely to speak. For example, the language identification module 116 may generate confidence scores 126 only for languages associated with a speech recognizer 114. In some configurations, these languages may be selected based on, for example, data associated with the user 102 in user profile data stored by the computing system 112.

In some configurations, the computing system 112 may be configured to provide continuous or ongoing transcriptions 104 to the client device 108. Results may be presented in or near real-time as the user dictates. In some cases, the speech recognizers 114 may process the data 110 at different speeds and/or may provide the computing system 112 with preliminary results before providing final results. For example, the English speech recognizer 114a may process the speech data 110 faster than the Spanish speech recognizer 114b. In such a case, the computing system 112 may provide the English proposed transcription 118a to the client device 108 while the Spanish speech recognizer 114b, and optionally the English speech recognizer 114a, execute to produce their final results.

As noted above, each of the speech recognizers 114 and the language identification module 116 may operate independently of each other and of the computing system 112. Rather than wait for every speech recognizer 114 to provide output, the computing system 112 may wait until the end of a timeout period, and use the information from whichever of the modules that has responded within the timeout period. By setting an appropriate timeout period, a balance between responsiveness to the user 102 and accuracy may be achieved.

In such cases, the computing system 112 may create preliminary combined scores, similar to or different from the combined scores 128. These preliminary combined scores may not include all languages, for example if some speech recognizers 114 have not produced preliminary results.

In cases in which a preliminary transcription is provided to the client device 108 and when a final result has a higher combined score 128 than the combined score for the preliminary results, the associated final transcription 118 may be provided to the client device 108 as an update. The client device 108 may be configured to, for example, replace the preliminary transcription with the updated transcription. In cases in which the preliminary combined score is the same or greater than the greatest combined score 128, the computing system 112 may transmit no update, transmit a transcription 118 as an update, or take any other appropriate action.

Although one particular example is shown here, other systems may be used to accomplish similar results. For example, the speech recognition process may all be performed locally on the client device 108 or another device.

While one speech recognizer 114 per language, and one language per speech recognizer 114, is shown, other configurations are possible. For example, another system may have a speech recognizer 114 per dialect of one or more languages, and/or may have a speech recognizer 114 configured to recognize two or more languages.

Although not shown here, the computing system 112 may include or have access to speech recognizers 114 that are specific to other languages and not used for a particular user's 102 utterance 106. For example, data recording the user's 102 preferences or historic activity may indicate that the user 102 is fluent in English and Spanish, but not French or Chinese. The computing system 112, while including and/or having access to speech recognizers 114 specific to French and/or Chinese, may choose not to send the data 110 to those recognizers 114. In some configurations, the computing system 112 may send the data 110 to one, some, or all other speech recognizers 114.

In some implementations, the computing system 112 uses the combined scores 128, or the confidence scores 120 and/or 126, to determine boundaries where speech of one language ends and speech of another language begins. For example, output of the language models 114 may be used to identify likely boundaries between words. The computing system 112 can define the speech between each of the boundaries as a different speech segment, and may select the most likely language for each speech segment. The computing system 112 may then splice together the transcriptions of various speech recognizers to determine the final transcription, with each speech segment being represented by the transcription corresponding to its selected language.

FIG. 2 is a block diagram of an example of a processing pipeline 200 for a speech recognition module. The processing pipeline 200 may be used, for example, by the language identification module 116, as described with reference to FIG. 1. Although a particular number, type, and order of pipeline elements are shown here, different numbers, types, or orders of pipeline elements may be used in other configurations to achieve the same or similar results.

A filterbank 202 may receive data representing an utterance, for example data 110 or other data. The filterbank 202 may be configured as one or more filters (e.g., band-pass, discrete-time, continuous-time) that can separate the received data into frames. These frames may represent a time-based partitioning of the received data, and thus the utterance. In some configurations, each frame may represent a period of time on the order of milliseconds (e.g., 1 ms, 10 ms, 100 ms, etc.). A frame stacker 204 may, for each particular frame generated by the filterbank 202, stack surrounding frames with the particular frame. For example, the previous 20 and following 5 frames may be stacked with a current frame. In this case, each stack can represent 26 frames of the data 110. If each frame represents, for example, 10 ms of speech, then the stack represents 260 ms of an utterance.

A Voice Activity Detection (or VAD) segmenter 206 may, for each stack of frames, segment out portions of that represent no voice activity. For example, when an utterance includes a pause between utterances, portions of or all of a stack of frames may represent some or all of that pause. These stacks or portions of the stacks may be segmented out so that, for example, they are not examined further down the pipeline.

A normalizer 208 may normalize the segmented stacks of frames. For example, the normalizer 208 may be configured to normalize the stacks such that each stack contains the same mean and standard deviation of a parameter or parameters of the stacks. This normalization may be useful, for example, to normalize stacks related to utterances with variable volume, static interference, or other audio artifacts.

A neural network 210 may receive the normalized, segmented stacks of frames and may generate confidence scores for each of a plurality of languages. In some configurations, the neural network 210 may be an artificial neural network, such as a deep neural network. A deep neural network may be, for example, a neural network that contains a large number of hidden nodes compared to the number of edge nodes in the network.

A posterior analyzer 212 can use the output of the neural network 210 to perform an analysis and to log confidence scores for a plurality of languages. This analysis may be, for example, a Bayesian posterior probability analysis that assigns, for each language, a confidence or probability that the original utterance was in the associated language. These confidence values may be, for example, the confidence scores 126, described with reference to FIG. 1.

For each input stack of frames, the language identification module may produce multiple outputs, one for each of the languages that the language identification module is trained to identify. As additional input is provided, additional confidence values are produced. For example, a new input stack may be input for each 10 ms increment of speech data, and each input can have its own corresponding set of outputs. A computing system or the language identification module itself may average these outputs together to produce an average score. For example, ten different English language confidence scores may be averaged together, each representing estimates for a different 10 ms region of speech, may be averaged together to generate a single confidence score that represents a likelihood for the entire 100 ms period represented by ten different input stacks. Averaging the individual outputs of a neural network or other model can improve the overall accuracy of the speech recognition system.

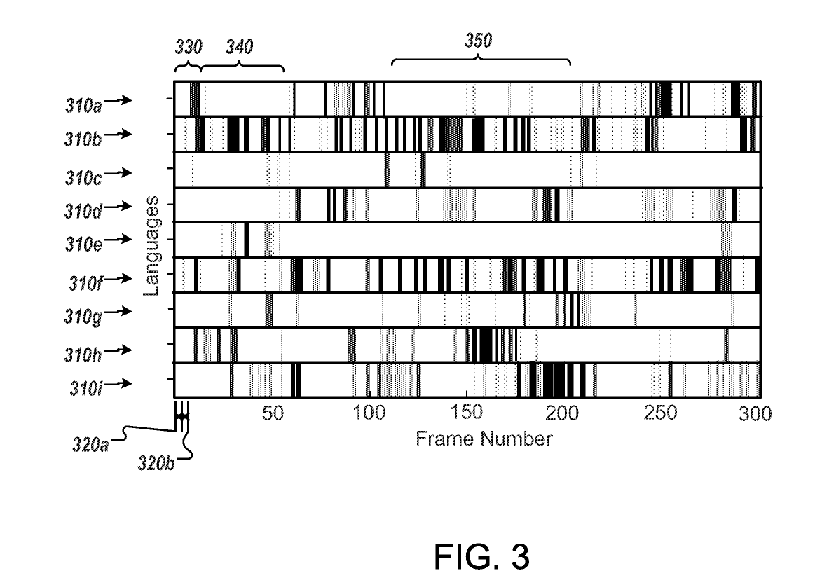

FIG. 3 is a schematic diagram of example data 300 related to speech recognition confidence scores. The data 300 may be a visualization of, for example, confidence scores generated by the language identification module 116 of FIG. 1. In some configurations, the computing system 112 may never generate the visualization as shown, instead operating on the data in non-visual form.

The data 300 as shown is organized into a two-dimensional table. The table includes rows 310a-310i that each correspond to a different language. For example, the row 310a may indicate confidence score values for English, the row 310b may indicate confidence score values for Spanish, the row 310c may indicate confidence score values for French, and so on. The languages may be, for example, each of the languages that a language identification module is trained to evaluate.

Each row 310a-310i indicates a sequence of language identification module confidence scores for a corresponding language, where the scores may be, for example, the output of a trained neural network. The different values correspond to estimates based on different speech frames of an utterance, with the values from left to right showing a progression from beginning to end of the utterance. For example, scores are shown for a first analysis period 320a, which may indicate a first 10 ms frame of an utterance, other scores are shown for a second analysis period 320b that may indicate a subsequent 10 ms frame of the utterance, and so on. For each frame, a different score may be determined for each of language.

For each frame, the table includes a cell that is shaded based on the confidence value for the associated speech frame and language. In the example, values range from zero to 1, with darker regions representing higher probability estimates, and lighter regions representing lower probability estimates. The data 300 shows that the estimates of which language is being spoken may vary from frame to frame, even for an utterance in a single language. For example, the scores in the region 330 suggest that the utterance is in English, but the scores for the region 340 suggest that the utterance is in Spanish. Accordingly averaging values across multiple frames may help to provide consistency in estimating a language.

Further, the data 300 shows that, in the region 350, the scores may not clearly indicate which language is being spoken. In the example, the estimates for multiple languages suggest that several languages are equally likely. Since confidence scores based on acoustic features may not always indicate the correct language, or may not identify the correct language with high confidence, confidence scores from language models may be used to improve accuracy, as discussed with respect to FIG. 1.

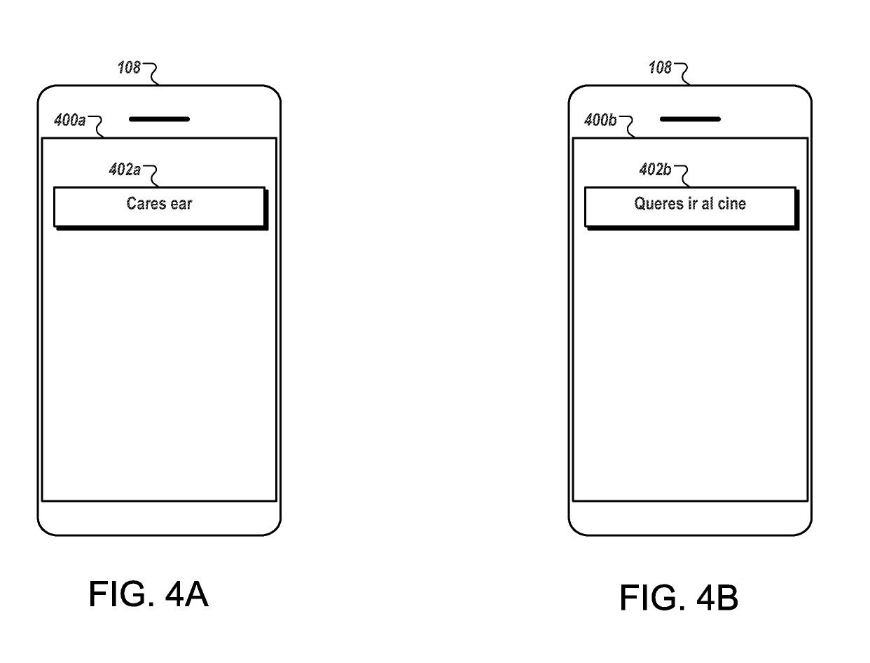

FIGS. 4A and 4B show an example user interface 400 showing a preliminary transcription replaced by another transcription. In this example, the client device 108, as described with reference to FIG. 1, is shown as generating the user interface 400. However, in other examples, other computing hardware may be used to create the user interface 400 or another user interface for displaying transcriptions.

As shown, the user interface 400 includes an input field 402. The user interface 400 may provide a user with one or more ways to submit text to the input field 402, including but not limited to the speech-to-text as described, for example, with respect to FIG. 1. In this example, the user interface 400a displays a preliminary transcription in the input field 402a. For example, the user may have entered an utterance in an unspecified language. A preliminary transcription of “Cares ear,” which includes English words, is generated by the client device 108 and/or networked computing resources communicably coupled to the client device 108.

After displaying the preliminary transcription, and as additional speech is analyzed, the speech recognition system may determine that the correct language is different from the language of the preliminary transcription. As a result, the speech recognition system may provide a final transcription that replaces some or all of the preliminary transcription. For example, the client device 108 may receive input that replaces the preliminary transcription with a final transcription of “Queres it al cine”, as shown in the input field 402b. In this example, the preliminary transcription shown in the input field 402a is an English language transcription, and the final transcription shown in the input field 402b is in a different language—Spanish. In other examples, the preliminary and final transcriptions may be in the same language having the same or different text.

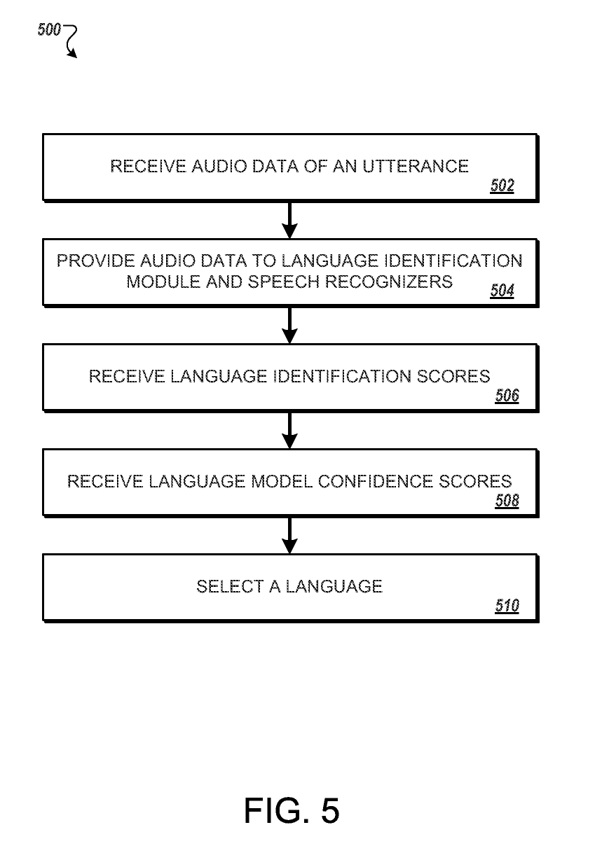

FIG. 5 is a flowchart of an example process 500 for speech recognition. The example process 500 will be described here with reference to the elements of the system 100 described with reference to FIG. 1. However, the same, similar, or different elements may be used to perform the process 500 or a different process that may produce the same or similar results.

Speech data for an utterance is received (502). For example, the user 102 can navigate to an input field and press an interface button indicating a desire to submit speech-to-text input. The client device 108 may provide the user 102 with a prompt, and the user 102 can speak utterance 106 into the user's 102 client device 108. In response, the client device 108 may generate data 110 to represent the utterance 106 and transmit that data 110 to the computing system 112.

Speech data is provided to (i) a language identification module and (ii) multiple speech recognizers that are each configured to recognize speech in a different language (504). For example, the computing system 112 may identify one or more candidate languages that the utterance 106 may be in. For example, the computing system 112 may use the mobile computing device's 108 geolocation information and/or data about the user 102 to identify candidate languages. For each candidate language, the computing system 112 may make a request or provide the data 110 to a corresponding language-specific speech recognizer 114 via, for example, a remote procedure call. Additionally, the computing system 112 may make a request or provide the data 110 to the language identification module 116 via, for example, a remote procedure call.

Language identification scores corresponding to different languages are received from the language identification module (506). The language identification scores each indicate a likelihood that the utterance is speech in the corresponding language. For example, the language identification module 116 may use a processing pipeline, such as the processing pipeline 200 as described with reference to FIG. 2, or another processing pipeline or other structure to generate confidence scores 126. The language identification module 116 may return these confidence scores 126 to the computing system 112, for example by return of a remote procedure call.

A language model confidence score that indicates a level of confidence that a language model has in a transcription of the utterance in a language corresponding to the language model is received from each of the multiple speech recognizers (508). For example, the speech recognizers 114 may generate confidence scores 120 using, for example, the acoustic models 122 and language models 124. The speech recognizers 114 may return these confidence scores 120 to the computing system 112, for example by return of remote procedure calls.

A language is selected based on the language identification scores and the language model confidence scores (510). For example, the computing system 112 may use the confidence scores 126, the confidence scores 120, and optionally other data to determine the most likely language of the utterance 106. Once the most likely language is selected, the corresponding transcription 118 may be transmitted by the computing system 112 to the mobile computing device 104 such that the transcription 118 is displayed to the user 102.

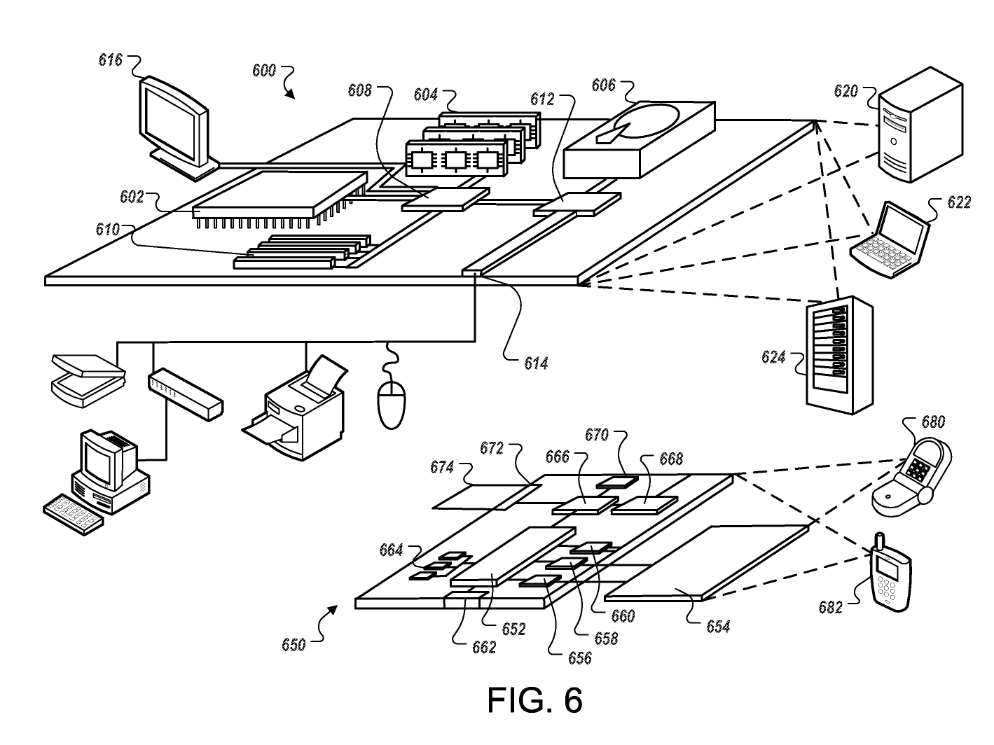

FIG. 6 shows an example of a computing device 600 and an example of a mobile computing device that can be used to implement the techniques described here. The computing device 600 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is exemplary only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 664, the expansion memory 674, or memory on the processor 652. In some implementations, the computer program product can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method performed by one or more computers, the method comprising:
receiving speech data for an utterance;
providing the speech data to (i) a language identification module and (ii) multiple speech recognizers that are each configured to recognize speech in a different language;
receiving, from the language identification module, language identification scores corresponding to different languages, the language identification scores each indicating a likelihood that the utterance is speech in the corresponding language;
receiving, from each of the multiple speech recognizers, a language model confidence score that indicates a level of confidence that a language model has in a transcription of the utterance in a language corresponding to the language model; and
selecting a language based on the language identification scores and the language model confidence scores.

2. The method of claim 1, wherein receiving the speech data for the utterance comprises receiving the speech data from a user over a network;
wherein the method further comprises:
receiving, from each of the speech recognizers, a transcription of the utterance in a language corresponding to the speech recognizer; and
providing the transcription in the selected language to the user over the network.

3. The method of claim 2, further comprising, before receiving, from each of the speech recognizers, a transcription of the utterance in a language corresponding to the speech recognizer:
receiving, from a particular one of the multiple speech recognizers, a preliminary transcription of the utterance in a language corresponding to the speech recognizer;
providing the preliminary transcription to the user over the network before providing the transcription in the selected language to the user over the network.

4. The method of claim 3 wherein the preliminary transcription is in the selected language.

5. The method of claim 3 wherein the preliminary transcription is a language different than the selected language.

6. The method of claim 3 wherein the preliminary transcription is provided over the network for display to the user; and
wherein the transcription in the selected language is provided for display in place of the preliminary transcription, after the preliminary transcription has been provided over the network.

7. The method of claim 3 wherein the method further comprises:
receiving, from the particular one of the multiple speech recognizers, a preliminary language model confidence score that indicates a preliminary level of confidence that a language model has in the preliminary transcription of the utterance in a language corresponding to the language model; and
determining that the preliminary language model confidence score is less than a language model confidence score received from the particular one of the multiple speech recognizers.

8. The method of claim 1, wherein providing the speech data to a language identification module comprises providing the speech data to a neural network that has been trained to provide likelihood scores for multiple languages.

9. The method of claim 1, wherein selecting the language based on the language identification scores and the language model confidence scores comprises:
determining a combined score for each of multiple languages, wherein the combined score for each language is based on at least the language identification score for the language and the language model confidence score for the language; and
selecting the language based on the combined scores.

10. The method of claim 9, wherein determining a combined score for each of multiple languages comprises weighting the likelihood scores or the language model confidence scores using one or more weighting values.

11. The method of claim 1, wherein receiving the speech data comprises receiving speech data that includes an utterance of a user;
further comprising:
before receiving the speech data, receiving data indicating multiple languages that the user speaks;
storing data indicating the multiple languages that the user speaks;
wherein providing the speech data to multiple speech recognizers that are each configured to recognize speech in a different language comprises, based on the stored data indicating the multiple languages that the user speaks, providing the speech data to a set of speech recognizers configured to recognize speech in a different one of the languages that the user speaks.

12. A non-transitory computer storage medium tangibly encoded with computer program instructions that, when executed by one or more processors, cause a computer device to perform operations comprising:
receiving speech data for an utterance;
providing the speech data to (i) a language identification module and (ii) multiple speech recognizers that are each configured to recognize speech in a different language;
receiving, from the language identification module, language identification scores corresponding to different languages, the language identification scores each indicating a likelihood that the utterance is speech in the corresponding language;
receiving, from each of the multiple speech recognizers, a language model confidence score that indicates a level of confidence that a language model has in a transcription of the utterance in a language corresponding to the language model; and
selecting a language based on the language identification scores and the language model confidence scores.

13. The medium of claim 12, wherein receiving the speech data for the utterance comprises receiving the speech data from a user over a network;
wherein the operations further comprise:
receiving, from each of the speech recognizers, a transcription of the utterance in a language corresponding to the speech recognizer; and
providing the transcription in the selected language to the user over the network.

14. The medium of claim 13, the operations comprising, before receiving, from each of the speech recognizers, a transcription of the utterance in a language corresponding to the speech recognizer:
receiving, from a particular one of the multiple speech recognizers, a preliminary transcription of the utterance in a language corresponding to the speech recognizer;
providing the preliminary transcription to the user over the network before providing the transcription in the selected language to the user over the network.

15. The medium of claim 12, wherein receiving the speech data comprises receiving speech data that includes an utterance of a user;
the operations further comprising:
before receiving the speech data, receiving data indicating multiple languages that the user speaks;
storing data indicating the multiple languages that the user speaks;
wherein providing the speech data to multiple speech recognizers that are each configured to recognize speech in a different language comprises, based on the stored data indicating the multiple languages that the user speaks, providing the speech data to a set of speech recognizers configured to recognize speech in a different one of the languages that the user speaks.

16. A system comprising:
one or more processors; and
a non-transitory computer storage medium tangibly encoded with computer program instructions that, when executed by the one or more processors, cause a computer device to perform operations comprising:
receiving speech data for an utterance;
providing the speech data to (i) a language identification module and (ii) multiple speech recognizers that are each configured to recognize speech in a different language;
receiving, from the language identification module, language identification scores corresponding to different languages, the language identification scores each indicating a likelihood that the utterance is speech in the corresponding language;
receiving, from each of the multiple speech recognizers, a language model confidence score that indicates a level of confidence that a language model has in a transcription of the utterance in a language corresponding to the language model; and
selecting a language based on the language identification scores and the language model confidence scores.

17. The system of claim 16, wherein receiving the speech data for the utterance comprises receiving the speech data from a user over a network;
wherein the operations further comprise:
receiving, from each of the speech recognizers, a transcription of the utterance in a language corresponding to the speech recognizer; and
providing the transcription in the selected language to the user over the network.

18. The system of claim 17, the operations comprising, before receiving, from each of the speech recognizers, a transcription of the utterance in a language corresponding to the speech recognizer:
receiving, from a particular one of the multiple speech recognizers, a preliminary transcription of the utterance in a language corresponding to the speech recognizer;
providing the preliminary transcription to the user over the network before providing the transcription in the selected language to the user over the network.

19. The system of claim 18, wherein the preliminary transcription is provided over the network for display to the user; and
wherein the transcription in the selected language is provided for display in place of the preliminary transcription, after the preliminary transcription has been provided over the network.

20. The system of claim 18, wherein the operations further comprises:
receiving, from the particular one of the multiple speech recognizers, a preliminary language model confidence score that indicates a preliminary level of confidence that a language model has in the preliminary transcription of the utterance in a language corresponding to the language model; and
determining that the preliminary language model confidence score is less than a language model confidence score received from the particular one of the multiple speech recognizers.
